(19) United States
(12) Patent Application Publication
(10) Pub. No.: US 2013/0254206 A1
(43) Pub. Date: Sep. 26, 2013

(54) Information Entropy-Based Sampling of Social Media

(71) Applicants: Scott J. Counts, Seattle, WA (US); Munmun De Choudhury, Bellevue, WA (US); Mary P. Czerwinski, Kirkland, WA (US)

(72) Inventors: Scott J. Counts, Seattle, WA (US); Munmun De Choudhury, Bellevue, WA (US); Mary P. Czerwinski, Kirkland, WA (US)

(73) Assignee: MICROSOFT CORPORATION, Redmond, WA (US)

(21) Appl. No.: 13/425,329

(22) Filed: Mar. 20, 2012

(51) Int. Cl. G06F 17/30

(52) U.S. Cl. 707/738; 707/E17.089

(57) ABSTRACT

The subject disclosure is directed towards a technology by which content items such as microblog postings may be returned to a requestor based upon a desired level of diversity based upon information entropy. Each content item is associated with a set of dimensions, which may have a learned relative importance, and the content items may be pruned into a pruned subset via a transform. A result set is constructed by finding a cluster of items having a level of entropy that is closest to a desired level. In one aspect, the result set may be ordered based upon evaluating distortion of each item in the result set.

### BACKGROUND

In general, with social media websites, end users can ‘broadcast’ information that interests them to others, as well as ‘listen’ to their peers by subscribing to their respective content streams. As a result, this provides real-time content dissemination to users for current topics.

However, social media comprise very large information spaces that may contain tens of thousands to hundreds of thousands of pieces of information about a given topic. In search (and related) scenarios, many users want to see only a very small subset of those many pieces (e.g., the ten “best” items). Determining which of those many items to show an end user is a complex problem.

For one, some users may want to see a widely diverse, heterogeneous subset of items. Others want may want a narrowly focused, homogenous set. For the end user, different levels of diversity in social media content can significantly impact the information consumption experience, in that low diversity can provide focused content that may be simpler to understand, while high diversity can increase breadth in the exposure to multiple opinions and perspectives.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which content items may be returned to a requestor based upon information entropy. Each content item is associated with a set of dimensions, and the Content items may be pruned into a pruned subset based upon the set of dimensions associated with each content item. A result set is constructed by processing the pruned subset, including finding a cluster of items having a level of entropy that is closest to a desired level. In one aspect, the result set may be ordered based upon evaluating distortion of each item in the result set. A relative importance of each dimension may be learned.

In one aspect, a clustering mechanism is configured to cluster content items into a result set of content items based upon selecting items for the result set that move the result set closer to a desired level of entropy. A content server responds for a request for content by returning a response based upon the result set. An ordering mechanism may rank the items for the response by processing the result set based upon distortion of entropy in the items.

Other advantages may become apparent from the following detailed description when taken in confunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a system that provides content items via information entropy-based sampling of social media, according to one example implementation

FIG. 2 is a flow diagram showing example steps that may be taken to process content items into a diversity-based response.

FIG. 3 is a block diagram representing an example computing environment into which aspects of the subject matter described herein may be incorporated.

### DETAILED DESCRIPTION

Various aspects of the technology described herein are generally directed towards selecting content (e.g., from social media, newsfeeds, blogs or the like) to return based on sampling the context according the degree to which the content matches a user-specified or system-specified level of diversity (entropy). For example, for a given topic, an end user may only want highly homogenous results, whereby the technology returns the top k (e.g., ten) items that when processed together match a low level of diversity. The diversity may be tied to one or more attributes of the data (e.g., low diversity on the geography of the author if the user wanted only results from people local to an event).

As described herein, diversity as a property of media content may be quantified via its measure of entropy in a conceptual structure referred to herein as a “diversity spectrum.” One aspect of returning user-desired content is thus directed towards determining content information samples on a topic that match a desired degree of diversity. To this end, a weighted dimensional representation of information units (e.g., microblog posts) characterizing large-scale social media spaces is provided herein, along with a sampling methodology to reduce such large social media spaces. The sampling methodology is based upon compressive sensing concepts that represent an information stream via a small set of basis functions, assuming the stream is fairly sparse.

An iterative clustering framework on the reduced space is used for the purpose of sample generation, based upon a greedy approach-based entropy minimization technique to generate samples of a particular sampling ratio and matching a desired level of diversity. To this end, the technology uses information entropy to sample content. This may include considering social media as an information space that can be characterized in terms of its entropy across some number of dimensions (comprising various attributes of the items). Also described is using compressive sensing to reduce the size of the data without inducing information loss.

It should be understood that any of the examples herein are non-limiting. For instance, the examples are generally described with respect to sampling social media, however any content including newsfeeds, blogs and so forth may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and processing content in general.

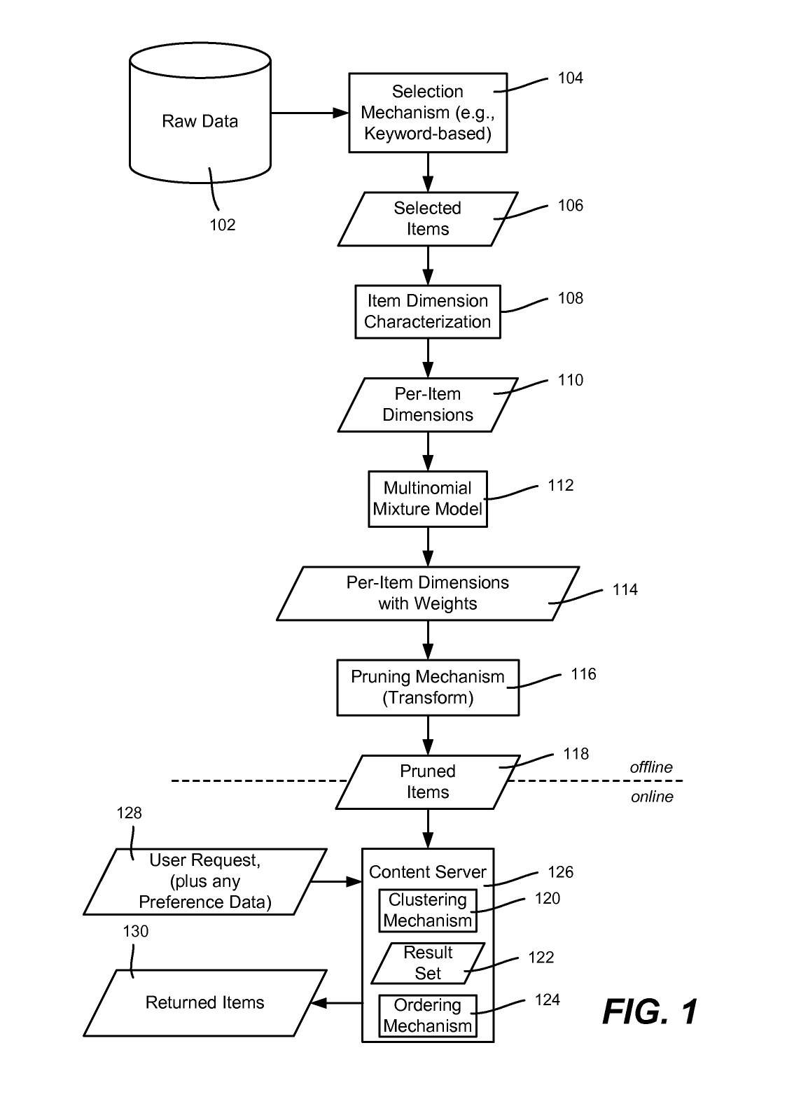

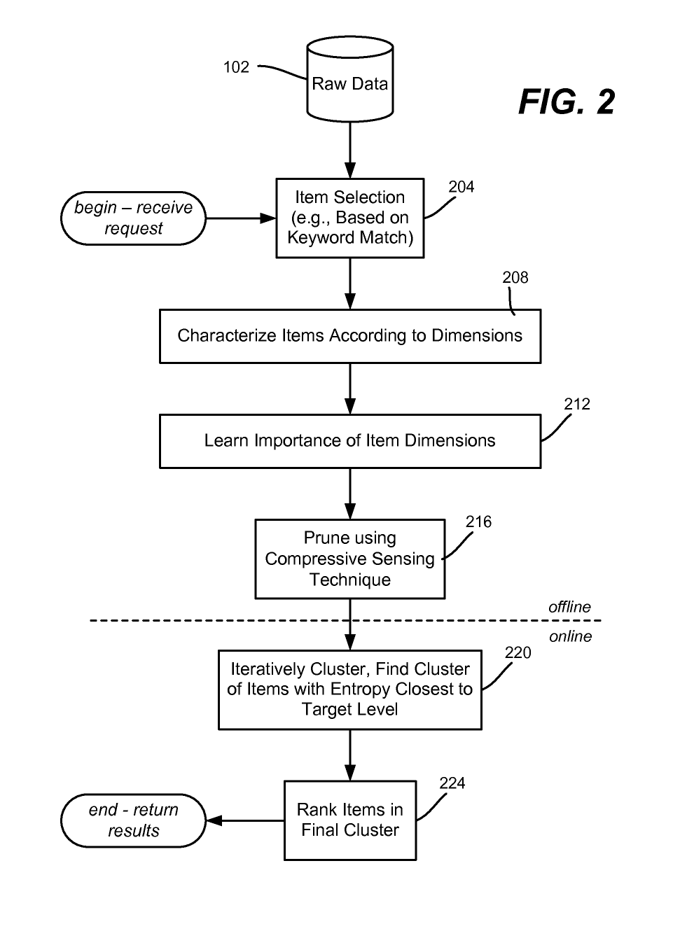

FIGS. 1 and 2 show a block diagram and flow diagram, respectively, of an example implementation for selecting content items based upon a desired level of diversity. For example, content may of virtually any theme (e.g., political and economic perspectives on the same topic), may be posted by individuals in disparate geographic locations, may be updates from a popular person such as celebrity, or may be conversational between two or more individuals with conflicting opinions. In essence, social media information spaces are of high dimensionality, a characteristic property that may be referred to herein as “diversity”.

A set of raw data 102 such as microblog posts is processed via a selection mechanism 104/step 204 to obtain a set of items 106, such as based on keywords that are relevant to a currently popular topic. For example, the items may be selected to match a particular search string such as “Windows phone”; (note that the registered trademark symbol for Windows® was omitted in the search string to reflect what users typically type). For popular topics, the raw data may be on the order of tens of thousands to hundreds of thousands of items over just a few days.

Block 108 (FIG. 1)/step 208 (FIG. 2) are directed towards numerically characterizing each item over a set of dimensions, based on the item's attributes, as further described below. Dimensions for a microblog content posting may include one or more content-related dimensions, thematic dimensions and/or author-related dimensions, for example. Example content-related dimensions may include diffusion-related properties, the responsive nature of the content (e.g., the content was a re-post of content from another user, or was a reply to another user), presence of any URL, temporal information and/or location information. Example thematic dimensions may include a topical set of features over a broad set of themes. Example author dimensions may include structural features (e.g., author followers/followings), activity of author, and so forth. Additional information regarding dimensions is described below.

Given the dimensions 110 for each item, a multinomial mixture model 112 learns the relative importance of each dimension (block 114), as also represented at step 212 of FIG. 2. One suitable example multinomial mixture model is described below with reference to equation (4).

For large amounts of content, which is a common scenario, a pruning mechanism 116 (step 216 of FIG. 2) may be used to eliminate a large percentage of the content without losing information. This may be accomplished via a compressive sensing process. One example implementation uses a Haar wavelet transform to find a transformation matrix in which the transformation for a large amount of content yields a significantly smaller matrix than the original matrix, as represented by block 118. Such a transform is substantially lossless, whereby most of the information is not lost upon an inverse transformation. Additional details regarding the pruning are set forth below.

From the remaining content, an iterative clustering mechanism 120 (a process corresponding to step 220 of FIG. 2) is used that begins with a seed item and iteratively constructs a result set by adding items that get the overall result set closer to the specified level of information diversity (i.e., minimize the error from the desired level of entropy). The results in the selected cluster may be ordered/ranked (block 124 in FIG. 1, step 224 in FIG. 2) via the distortion of entropy in each item, as described below, e.g., the item with the lowest distortion with respect to the desired level of entropy in the result set is ranked first, and so on.

Clustering and ordering may be an online processing step performed by a content server 126 in response to a user request 128, with the returned, ordered items 130 based upon the constructed result set 122. Note that the user may provide preference data with the request, e.g., a desired level of diversity, as well as possibly other information, such as geographic location that may be used as part of the overall selection process. The server alternatively may determine the desired level of diversity. Note that any of the data may be cached for efficiency, e.g., the pruned items, results set, and/or sets of the returned items may be pre-computed for various diversity levels and cached for responding to user requests.

Turning to additional details of one example implementation, in order to leverage diversity when sampling, consideration is given to the wide variety of ways an end user may use diversity when searching for topic-centric social media content. By way of example, a user searching for content after the release of the Windows® Phone may intend to find homogenous samples (corresponding to low diversity), e.g., content posted only by technical experts. Homogenous samples with low diversity thus may apply to scenarios where the user seeks focused information qualifying certain prerequisites (knowledge depth).

In another example situation, a user interested in learning about a current news story likely prefers an appropriate sample that is heterogeneous in terms of the “mixing” of its attributes (high diversity); such sampled content therefore likely spans over attributes such as author, geography and themes like politics or finance. Highly diverse content, being heterogeneous in its representation of various attributes, is likely to benefit the user in terms of information gain along multiple facets (knowledge breadth). By way of example, the user may wish to sample content about Windows® Phone from both technology experts and “everyday users.”

Depending on the thematic category of content, the choice of the dimensional type (e.g., microblog posting-related features like recency, nodal features like the social graph topology of the author) may make a notable difference to the samples generated. Ultimately it is the end users who decide the quality of samples in a topic-centric search context. Social media spaces are different from other sources because of the nature of user generated content, including its high dimensionality and diversity.

Diversity spectrum comprises a conceptual structure that quantifies the measure of diversity in a social media information sample. Any point on the spectrum can be specified in the form of a diversity parameter (represented herein by ω, which is any real value in the range [0, 1]. The information-theoretic metric “entropy” is used to represent the diversity parameter that matches a generated sample. Samples with near zero entropy (or a diversity parameter value of near zero) are highly homogenous, while those with entropy nearing one, at the other end of the spectrum, are highly heterogeneous.

As described above, various attributes referred to as dimensions are used to sample social media information content on a certain topic. For example, different dimensions may be defined in the context of a microblog site such as Twitter®, where the information space comprises the content postings of users in any given time period. A wide range of dimensions that characterize such content postings based on their content, their temporal attributes and dynamics as well as the structural properties of their creators in the social network as a whole. Example dimensions of social media content are set forth in the following table:

| | |
|---|---|
| 1 | Diffusion property of the microblog posting, e.g., measured via |
| | whether the given posting is a “re-posting”. |
| 2 | Responsivity nature of the posting, e.g., measured via whether a |
| | given posting is a “reply”. |
| 3 | Presence of external information reference in the posting, e.g., a |
| | URL. |
| 4 | Temporal information i.e. time-stamp of the posting. |
| 5 | Location attribute of the posting, e.g., given by the time zone |
| | information on the profile of the posting author. |
| 6 | The thematic association of the posting within a set of categories, |
| | such as “Business, Finance”, “Politics”, “Sports” or “Technology, |
| | Internet”. |
| 7 | Structural features of the posting author, e.g., number of followers |
| | and number of followings/friends |
| 8 | Degree of activity of the posting author, e.g., given by the number of |
| | status updates. |

The above example dimensions may be grouped into categories, e.g., social characteristics (dimensions 1-5), content characteristics, (dimension 6) and nodal characteristics, (dimensions 7 and 8). Other dimensions may be used instead of or in addition to those set forth in the above example. Example other types of attributes may include sentiment or linguistic style of the content, relationship strength between the creator of content and the consuming end user, community attrition of the creator and the consumer, sophisticated network metrics of the consumer, such as clustering coefficient or embeddedness, and so on. Incorporating such attributes might prove to be useful especially while personalizing the recommendation of social media content to users

Thus, given a stream of content postings from users in a time span, and filtered over a certain topic θ, e.g., T_{θ}, along with a diversity parameter co and a sampling ratio ρ, a task is to determine a (sub-optimal) sample \hat{T}_{ω}*(ρ) such that its diversity level (or entropy) is as close as possible to the desired diversity parameter ω and also has a suitable ordering of postings in the sample in terms of the entropy measure. As will be understood, this determination involves dimensional importance learning and social media content sampling, and a mechanism for sample generation that matches a desired value of the diversity parameter.

Dimensional importance is based upon a filtered set of postings T_{θ}, or simply T, corresponding to the topic θ. For each posting tᵢεT, a vectored representation of the posting is developed based on its values for the different dimensions. Let tᵢε [symbol] ^{1×K} represents the dimensional representation of a posting for the set of K dimensions. The mutual concentrations (in other words, “importance”) of the various dimensions Kin the occurrence of any posting needs to be determined. One way is through a survey of users, although automated techniques, one of which is described herein, may be used.

More particularly, in other text mining tasks, the observed distribution in documents is often described by multivariate mixture densities; assuming the same density for a microblog posting,

$$P ( {t}_{i} ) = {\sum }_{{}_{𝓁}} P ( {}_{𝓁} ) P ( {t}_{i} \vert {}_{𝓁} ) , \qquad ( 1 )$$

where it is assumed that the posting tᵢ is associated with a latent result set Tₗ, that is to be shown to the user. Hence based on a K component mixture model, the probability of occurrence of a posting tᵢ may be written as:

$$P ( {t}_{i} ) + {\sum }_{{}_{𝓁}} P ( {}_{𝓁} ) P ( {t}_{i} \vert {}_{𝓁} ) = {\sum }_{k = 1}^{K} {π}_{k} \cdot P ( {t}_{i} \vert {λ}_{k} ) , \qquad ( 2 )$$

where πₖ is the concentration parameter for the k-th dimension and P(tᵢ/λₖ) is the probability distribution corresponding to the k-th dimension, with parameters λₖ. Hence the likelihood function over the entire collection T is given as:

$$P ( \vert π , Λ ) = {Π}_{{t}_{i} ∈} {\sum }_{k = 1}^{K} {π}_{k} \cdot P ( {t}_{i} \vert {λ}_{k} ) , \qquad ( 3 )$$

where Λ=[γ₁, γ₂, . . . , γₖ₋₁, μₖ, Σₖ] is the vector of the model parameters of the different distributions on each dimension. The log likelihood function is therefore:

$$L ( π , Λ ) = ln P ( T \vert π , Λ ) = {\sum }_{{t}_{i} ∈ T} ln \{ {\sum }_{k = 1}^{K} {π}_{k} \cdot P ( {t}_{i} \vert {λ}_{k} ) \} . \qquad ( 4 )$$

The above log likelihood function may be maximized using the well-known expectation maximization (EM) algorithm as an iterative procedure for maximizing L(π, Λ). This gives the optimal estimates of the concentration parameters πₖ (and also Λ) for each dimension 1≦k≦K in the collection. Thus each posting tᵢ is given as tᵢ=[π₁·tᵢ₁, π₂·tᵢ₂, π_{K}·t_{iK}], where tᵢⱼ is the value of the j-th dimension for the microblog posting tᵢ. As will be understood, this weighted information space can be utilized in a sampling methodology to generate a sub-optimal sample \hat{T}_{ω}*(ρ) of a certain sampling ratio ρ and diversity ω.

In one implementation, the sampling methodology includes sample space reduction, sample generation and ordering of information units in the generated sample. Sample space reduction is directed towards the systemic pruning of the information space to disregard redundant or less relevant information and constructing samples satisfying a given pre-condition, such as minimizing a loss function. This is because, typically, the information space is very large to start with (e.g., in the order of millions). As described herein, “compressive sensing” is used, (which is based on signal processing technology that emphasizes that images or signals can be reconstructed reasonably accurately and sometimes even exactly from a number of samples that are far smaller in number than the actual resolution of the image or the signal; compressive sampling exploits the sparsity notion in signals to describe it as a linear combination of a very small number of basis components).

As described herein, concepts of compressive sensing may be leveraged to reduce the social media space, e.g., in the context of a microblog site, the sparsity property is assumed true for most postings, when each posting is described by the set of K sampling dimensions. Note that in practice many of the dimensions, such as thematic associations of a microblog posting, as well as diffusion property or re-posting, are non-zero only for a small percentage of the postings. As a result, an assumption is that the information space in general is compressible, meaning that the information space depends on a number of degrees of freedom that is smaller than the total number of instances N. Hence it can be written exactly or accurately as a superposition of a small number of vectors in some fixed basis.

Given Tε [symbol] ^{N×K}, the “underdetermined” case M<<N is of interest, where the intent is to have fewer measurements than actual information unit instances. Formally a smaller (transformed) matrix \hat{T}ε [symbol] ^{M×K} is found that allows reconstructing \hat{T}ε [symbol] ^{N×I} from linear measurements \hat{T} about T of the form:

Here M is the number of basis functions whose coefficients can reconstruct T (as \hat{T}) via linear measurements about T. M may be chosen based on the non-zero coefficients in the linear expansion of T. There are several standardized techniques that provide approximations to computing the transformation matrix φ; one used herein is the well-known “Haar wavelet” transform.

Turning to sample generation, described herein is an iterative clustering technique to generate a sub-optimal sample of a certain sampling ratio ρ, such that it corresponds to a chosen value (or pre-specified measure) of the diversity parameter on the diversity spectrum, given as ω. The clustering framework that utilizes the transformed (and reduced) information space \hat{T} follows a greedy approach and attempts to minimize distortion of entropy measures between the generated sample and the desired diversity parameter ω. One implementation constructs the sample \hat{T}_{ω}*(ρ) by starting with an empty sample, and picking any microblog posting (t₁) from the information space \hat{T} at random. Posting are iteratively added from the information space, (up to tᵢ for example), such that the distortion (in terms of l₁ norm) of entropy of the sample (\hat{T}_{ω}ⁱ) on addition of the posting tᵢ is least with respect to the specified diversity measure ω. That is, the posting \hat{T}εtᵢ is iteratively chosen such that its addition gives the minimum distortion of entropy of \hat{T}_{ω}ⁱ with respect to ω, where ω is the pre-specified diversity parameter as specified on the diversity spectrum. Note that the iterative process of adding one posting at a time to the sample continues until the sampling ratio ρ is sampled. This gets the optimal sample, \hat{T}_{ω}*(ρ).

An entropy distortion-based ordering technique of the content may be used with the sub-optimal sample to order the returned content. In general, the ordering may be based on how close the entropy of a particular piece of content is with respect to the specified diversity parameter. The distortion (l₁ norm) of a piece of content is computed given as H_{O}(tᵢ), with respect to ω. The lower the distortion, the higher the “rank” or position of the content posting tᵢ ordering in the final sample. This may be formalized as tᵢεT_{ω}ⁱ if and only if, ∥H_{O}(T_{ω}ⁱ)−ωl1<HOTωj−ωl1, ∀TjεT, where HOTωi is the normalized entropy given as H_{O}(T_{ω}ⁱ)=−Σₖ₌₁^{K}P(tᵢₖ)·log P(tᵢₖ)/Hₘₐₓ, and Hₘₐₓ being given as In K.

### Example Operating Environment

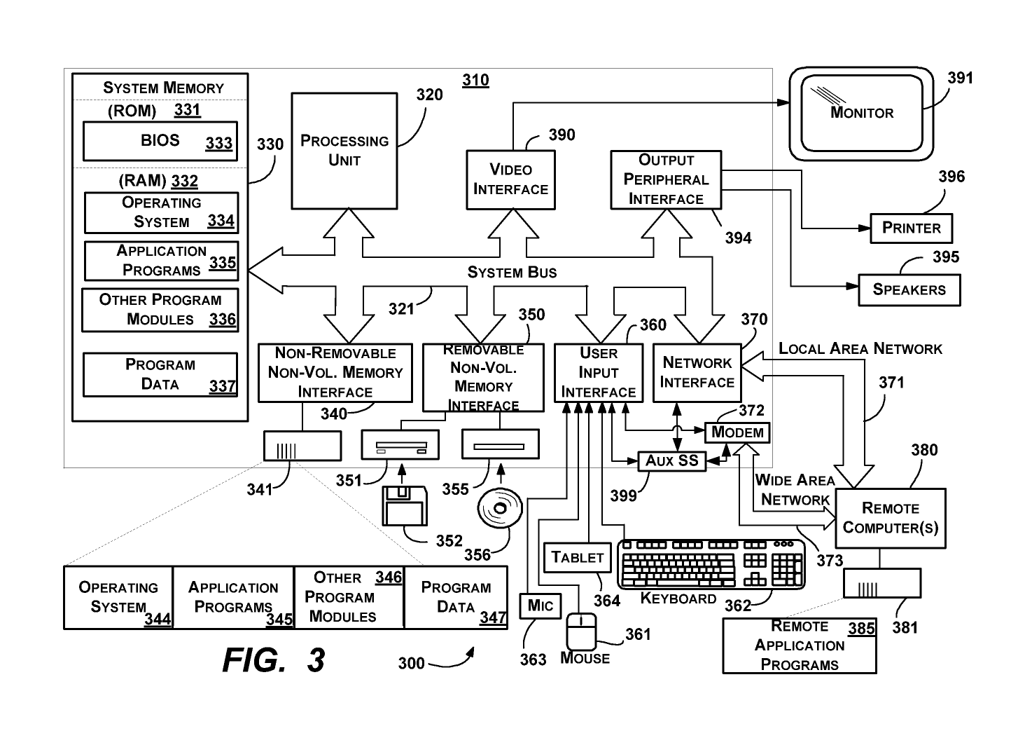

FIG. 3 illustrates an example of a suitable computing and networking environment 300 into which the examples and implementations of any of FIGS. 1 and 2 may be implemented, for example. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the example operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of Computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an example system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are examples and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, returning content items to an entity based upon information entropy, including associating each content item with a set of dimensions, pruning the content into a pruned subset based upon the set of dimensions associated with each content item, and constructing a result set by processing the pruned subset, including finding a cluster of items having a level of entropy that is closest to a desired level.

2. The method of claim 1 wherein finding the cluster of items having a level of entropy that is closest to a desired level iteratively making the result set closer to a desired level of entropy.

3. The method of claim 2 wherein iteratively making the result set closer to a desired level of entropy comprises iteratively adding items to the result set.

4. The method of claim 1 further comprising, selecting the content items from raw data based upon keyword matching.

5. The method of claim 1 further comprising, ordering the result set based upon evaluating distortion of each item in the result set.

6. The method of claim 1 further comprising, learning a relative importance of each dimension.

7. The method of claim 1 wherein pruning the content items comprises using a compressive sensing process comprising a Haar wavelet transform.

8. The method of claim 1 wherein pruning the content items comprises using a compressive sensing process.

9. The method of claim 8 wherein the compressive sensing process is substantially lossless, and further comprising, substantially reconstructing the set of content items from the pruned subset by performing an inverse transformation.

10. The method of claim 1 wherein associating each content item with a set of dimensions comprises associating each content item based at least in part on upon content-related dimensions.

11. The method of claim 1 wherein associating each content item with a set of dimensions comprises associating each content item based at least in part on upon thematic-related dimensions.

12. The method of claim 1 wherein associating each content item with a set of dimensions comprises associating each content item based at least in part on upon author-related dimensions.

13. One or more computer-readable media having computer-executable instructions, which when executed perform steps, comprising, processing content items that match a topic, including associating each content item with a set of dimensions, learning a relative importance of each dimension, and performing iterative clustering to iteratively construct a result set by adding items to the result set based upon a desired level of information diversity.

14. The one or more computer-readable media of claim 13 having further computer-executable instructions comprising, ordering the result set based upon evaluating distortion of each item in the result set with respect to the desired level of entropy.

15. The one or more computer-readable media of claim 13 having further computer-executable instructions comprising, pruning the content items via a compressive sensing process based upon the sets of dimensions associated with the content items prior to performing iterative clustering.

16. The one or more computer-readable media of claim 13 having further computer-executable instructions comprising, pruning the content items via a wavelet transform based upon the sets of dimensions associated with the content items prior to performing iterative clustering.

17. The one or more computer-readable media of claim 13 wherein learning the relative importance of each dimension comprises using a multinomial mixture model.

18. The one or more computer-readable media of claim 13 wherein associating each content item with a set of dimensions comprises associating each content item based upon content-related dimensions, thematic-related dimensions, or author-related dimensions, or any combination of content-related dimensions, thematic-related dimensions, or author-related dimensions.

19. A system comprising, a clustering mechanism configured to cluster content items into a result set of content items based upon selecting items for the result set that move the result set closer to a desired level of entropy, and a content server configured to respond for a request for content by returning a response based upon the result set.

20. The system of claim 19 further comprising an ordering mechanism configured to rank the items for the response by processing the result set based upon distortion of entropy in the items.
